(19) United States
(12) Patent Application Publication
(10) Pub. No.: US 2023/0382014 A1
(43) Pub. Date: Nov. 30, 2023

(54) PLANT FOR DRYING GRANULAR POLYMER MATERIAL

(71) Applicant: PEGASO INDUSTRIES S.P.A., Borgoricco (PD) (IT)

(72) Inventor: Rinaldo PIVA, Borgoricco (PD) (IT)

(73) Assignee: PEGASO INDUSTRIES S.P.A., Borgoricco (PD) (IT)

(21) Appl. No.: 18/030,760

(22) PCT Filed: Oct. 15, 2021
(86) PCT No.: PCT/IB2021/059503

§ 371 Date: Apr. 6, 2023

(30) Foreign Application Priority Data
Oct. 16, 2020 (IT) 102020000024507

(51) Int. Cl. B29B 13/06; F26B 17/12; F26B 21/08; F26B 25/00

(52) U.S. Cl. CPC B29B 13/065; F26B 17/12; F26B 21/083; F26B 25/006; B29B 2013/005

(57) ABSTRACT

A plant for drying granular polymer material comprises a hopper, in which granular polymer material is dried, and a process gas circuit which is configured to supply a process gas to the hopper in order to dry the granular polymer material.

### TECHNICAL FIELD

The present invention relates to a plant for drying granular polymer material.

### TECHNOLOGICAL BACKGROUND

The invention is particularly used in industrial processes for converting plastics material into granules by means of extrusion or moulding. It is known that such operations require, in order to ensure an adequate level of quality of the moulded product, that the plastics material which is introduced into the moulds have as much humidity removed as possible. However, this requirement is not very compatible with the high levels of hygroscopic properties of some plastics materials which are increasingly used in the field, such as, for example, those based on recycled polyethylene terephthalate (rPET).

Therefore, these plastics materials, before being subjected to the extrusion or moulding process, have to be advantageously processed in suitable drying plants where the content of water of the granules is reduced to the minimal quantities required by the conversion process.

In a commonly used process, the drying of the granular polymer material is carried out inside a hopper, in which the material to be dried is placed and in which there is introduced a continuous flow of a process gas which is hot and dry and which, by coming into contact with the granular material, provides for stripping the water present in the granules.

The process gas, which is typically air, before being introduced into the hopper in order to come into contact with the granular material to be dried, is dehumidified in a suitable dehumidification unit and is subsequently heated to the desired temperature.

In a known example of a drying plant, the process gas being discharged from the hopper is placed back into circulation in order to be dehumidified, heated and reintroduced into the hopper again.

A main disadvantage of this prior art is that the resin loaded in the hopper and the process gas which is blown in through the resin contain some contaminating substances, such as, for example, residues of benzene and relevant derivatives, acetaldehyde (AA) and possible residual oils resulting from the recovery cycle of the recycled PET.

It is evident that these contaminating substances present in the plastics material which is introduced into the moulds irreparably compromise the quality level of the moulded product.

The market requires increasing quantities of rPET and the quality of the rPET tends to be worse and worse, therefore, the search for solutions which allow a reduction in the chemical impurities in the plastics material constitutes a requirement which is particularly felt in the technical field in question.

### STATEMENT OF INVENTION

The problem addressed by the present invention is to provide a drying plant which is structurally and functionally configured to at least partially overcome one or more of the disadvantages set out above with reference to the cited prior art.

In particular, an object of the present invention is to provide a drying plant which reduces the chemical impurities of the plastics materials with respect to a conventional drying plant as described above with reference to the prior art.

An object of the present invention is also to provide a drying plant which reduces the overall emission of polluting substances with respect to a conventional drying plant as described above with reference to the prior art. Furthermore, an object of the present invention is to provide a drying plant which has a greater level of energy efficiency with respect to a conventional drying plant as described above with reference to the prior art.

Another object of the invention is to provide a drying plant which is simple to construct and carry out.

The problem and the objects indicated above are solved and overcome by the present invention by means of a drying plant comprising one or more of the features of the appended claims.

In a first aspect thereof, the invention is directed towards a plant for drying granular polymer material, comprising a hopper, in which the granular polymer material is dried, and a process gas circuit, which is configured to supply a process gas to the hopper in order to dry the granular polymer material.

The process gas circuit comprises a dehumidification and heating unit which is configured to dehumidify and heat the process gas to predefined humidity and temperature values for supply to the hopper, respectively.

The process gas circuit further comprises a purification group which is positioned at the outlet from the hopper and upstream of the dehumidification and heating unit and which is configured to purify the process gas from contaminating substances which are released by the granular polymer material in the hopper.

The purification group comprises a condenser which is configured to cool the process gas to a predefined condensation temperature of the contaminating substances so as to separate from the process gas the contaminating substances condensed in this manner.

The purification group further comprises a filter which is positioned at the outlet from the condenser and which contains activated carbon capable of absorbing any non-condensed contaminating substances.

In this manner, the purification group returns to the dehumidification and heating unit the process gas which is purified from the impurities which it accumulates during the passage of the hopper.

It will be appreciated that the plant for drying granular polymer material constructed according to the present invention is particularly suitable for drying granular polymer material which contains rPET. In fact, the purification group for the process gas is particularly effective for reducing the chemical impurities such as benzene and relevant derivatives, acetaldehyde (AA) and possible residual oils resulting from the recovery cycle of the recycled PET.

In an aspect, the condenser is configured to cool the process gas to a temperature between 10° C. and 30° C., preferably to a temperature between and 25° C., even more preferably to a temperature of substantially 20° C. It will be appreciated that these temperature ranges advantageously correspond to the condensation point of benzene and/or acetaldehyde. According to another advantageous aspect, the contaminating substances which are thereby condensed are conveyed through a discharge pipe towards a collection tank for the disposal thereof.

According to another advantageous aspect, the purification group comprises a first pipe for the process gas which is being discharged from the hopper and upstream of the condenser, and a second pipe for the process gas which is being discharged from the filter and upstream of the dehumidification and heating unit.

In this context, according to an embodiment, the purification group further comprises a heat exchanger which preferably includes the first pipe and the second pipe. The heat exchanger is advantageously configured to exchange heat between the process gas being introduced into the purification group through the first pipe and the process gas being discharged from the purification group through the second pipe.

As a result of this provision, the drying plant allows a better energy performance to be achieved.

In fact, the first branch discharges heat to the second branch so as to cool the process gas before it reaches the condenser. In this manner, the energy supply required for the condenser in order to reduce the temperature of the process gas to the predefined condensation temperature of the contaminating substances is reduced.

In an aspect, the heat exchanger is further configured to cooperate with the condenser so as to cool the process gas to a suitable temperature for the dehumidification step.

The Applicant has assessed, in an indicative manner, the efficiency of the purification group when the process gas being introduced into the purification group has the following characteristics: temperature of approximately 80° C., humidity of approximately 1000 parts per million (ppm), approximately 65 parts per billion (ppb) of benzene and approximately 1.2 ppm of acetaldehyde. In this case, the drying plant which is constructed according to the present invention achieves a purification of the process gas so as to obtain a process gas being discharged from the purification group with the following characteristics: temperature of approximately 60° C., humidity of approximately 1100 ppm, benzene less than 10 ppb and acetaldehyde less than 0.4 ppm.

In addition to the evident reduction of the contaminating substances, it must be observed that the process gas, during the passage through the purification group, is subjected to a decrease in temperature which can be quantified at approximately 20° C., which has a positive influence on the subsequent dehumidification step.

In an aspect, the process gas circuit comprises a movement unit which is configured to move the process gas along the process gas circuit, more specifically between the dehumidification and heating unit, the hopper and the purification group, and furthermore preferably in the purification group between the heat exchanger, the condenser and the filter.

In another preferred embodiment, the process gas circuit further comprises a cyclone separator which is positioned at the outlet from the hopper and upstream of the purification group. The cyclone separator is preferably configured to separate the dust of the polymer material granules from the flow of process gas being introduced into the purification group.

By separating the dust from the process gas being introduced into the purification group, the cyclone prevents the dust from being able to obstruct the filter, inhibiting the action of the activated carbon. Therefore, the presence of the cyclone considerably extends the service-life of the filter and increases the absorption in the filter of the non-condensed contaminating substances.

The presence of the cyclone further prevents the dust—being introduced into the condenser—from being able to become combined with the condensate, obstructing not only the filter but also the pipes themselves of the purification group. Therefore, the presence of the cyclone allows the entire purification group to be maintained at the correct functional efficiency. In the absence of the cyclone, furthermore, some of the dust could pass through the filter and could accumulate in the dehumidification and heating unit which is connected downstream. Therefore, the presence of the cyclone upstream also prevents this possible disadvantage.

In some embodiments, the movement unit (for example, an impeller fan) is connected downstream of the cyclone with respect to the direction of flow of process gas. In this manner, the impeller of the fan or other components of the movement unit which are exposed to the flow of gas and which are therefore liable to become damaged in the presence of dust is/are also protected as a result of the action of the cyclone.

In a preferred embodiment, the process gas circuit is a closed circuit with an inlet pipe into the hopper located downstream of the dehumidification and heating unit, an outlet pipe from the hopper located upstream of the purification group, and an inlet pipe into the dehumidification and heating unit located downstream of the purification group.

In particular, along the circuit from the outlet of the hopper, there are the cyclone separator, then the heat exchanger, subsequently the condenser, followed by the filter and then again the heat exchanger, and then the dehumidification and heating unit.

### BRIEF DESCRIPTION OF THE DRAWINGS

The features and advantages of the invention will be better appreciated from the detailed description of a preferred embodiment thereof, which is illustrated by way of non-limiting example with reference to the appended drawings, in which:

FIG. 1 is a schematic view of a plant for drying granular polymer material which is constructed according to the present invention,

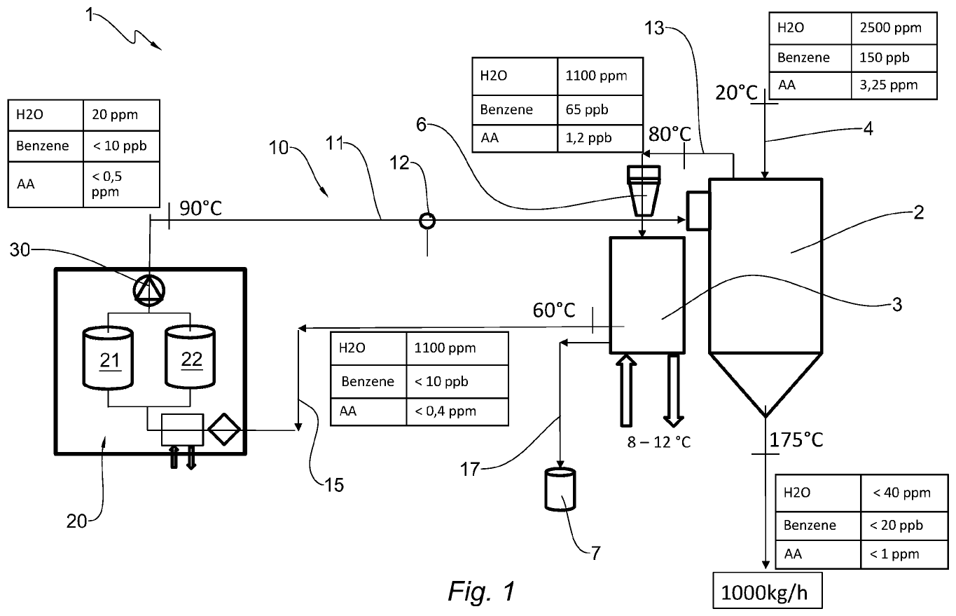

FIG. 2 is a schematic view of a detail of the plant of FIG. 1.

### PREFERRED EMBODIMENT OF THE INVENTION

In the Figures, there is generally designated 1 a plant for drying granular polymer material which is constructed according to the present invention. The plant 1 is provided to dry any polymer material in granules, for example, polyamide, polycarbonate or ABS copolymer even if, in the preferred example described herein, the material processed is formed at a ratio of approximately 50% by granules of recycled polyethylene terephthalate (rPET).

The plant 1 can be provided to supply a machine for converting the granular polymer material (not shown), such as, for example, a press or an extruder. The plant 1 comprises a loading line 4 which is provided to load the granular polymer material to be dried in the hopper 2.

The plant 1 further comprises a process gas circuit 10 which is associated with the hopper 2 in order to introduce therein a hot and dry process gas which, by passing through the granular material contained in the hopper 2, is capable of reducing the degree of humidity thereof to the levels desired and suitable for the subsequent processing steps.

The process gas may be air or an inert gas without oxygen.

In the example described herein, there is provided a single drying hopper but there may also be provided two or more hoppers which are arranged in series or parallel.

The process gas circuit 10 includes a dehumidification and heating unit 20 comprising a heating device which is provided to heat the process gas to the predefined temperature for introduction into the hopper 2. In the example described herein, in which the granular polymer material is a mixture containing 50% of rPET, the process gas is heated to approximately 90°.

In some embodiments, the dehumidification and heating unit 20 further comprises a pair of towers 21 and 22 which are mutually identical and which each contain a suitable quantity of drying compound, for example, zeolites.

Preferably, each tower 21, 22 has dimensions so as to dehumidify the process gas to a predefined humidity level, for example, corresponding to 20 parts per million (ppm) of water.

The towers 21 and 22 are connected to each other in parallel and are selectively and alternately able to be connected to the process gas circuit 10. According to another aspect, the process gas circuit 10 further comprises a movement unit 30, preferably comprising one or more blowers, in order to move the process gas along the process gas circuit 10.

Downstream of the dehumidification and heating unit 20, there is provided an inlet pipe 11, by means of which the process gas is introduced into the hopper 2. Along the inlet pipe 11 there can be provided a sampling location 12 for sampling the process gas. It is thereby possible to monitor, for example, the concentration of residual contaminating substances in the process gas. At the end of the inlet pipe 11, there is preferably mounted a diffuser (not shown) which is introduced into the granular polymer material contained in the hopper 2. After passing through the granular polymer material contained in the hopper 2, the process gas is discharged from the hopper through an outlet pipe 13. Preferably, the outlet pipe 13 leads to a cyclone separator 6.

The cyclone separator 6 is configured to separate the process gas from any dust which is carried from the interior of the hopper 2.

Downstream of the cyclone separator 6, if present, and upstream of the dehumidification and heating unit 20, the process gas circuit 10 comprises a purification group 3 which is configured to purify the process gas from contaminating substances which are released by the granular polymer material in the hopper.

The purification group 3 is connected to the dehumidification and heating unit 20 with a pipe 15 so as to bring the process gas back into circulation. In some embodiments, there is provided a bypass valve of the process gas which allows the purification group 3 to be excluded from the process gas circuit 10. In this manner, any maintenance operations for the purification group 3 do not require the operation of the entire plant to be necessarily stopped. Furthermore, the bypass valve allows the purification group 3 to be excluded when the characteristics of the material in the hopper and the process parameters should be such as not to require the removal of contaminating substances from the process gas.

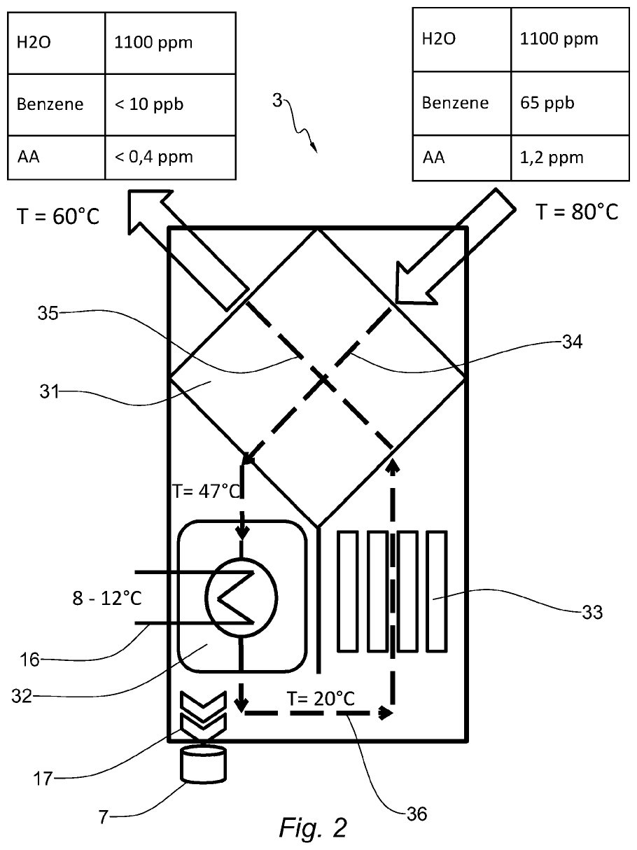

As set out in FIG. 2, the purification group 3 comprises a heat exchanger 31, a condenser 32 and a filter 33 which are connected to each other.

In particular, the heat exchanger 31 includes a first pipe 34 for the process gas being discharged from the hopper 2 and upstream of the condenser 32, and a second pipe 35 for the process gas being discharged from the filter 33 and upstream of the dehumidification and heating unit 20. The purification unit 3 further comprises a third pipe 36 at the outlet from the condenser 32 and upstream of the filter 33.

The heat exchanger 31 is configured to exchange heat between the process gas being introduced into the purification group 3 through the first pipe 34 and the process gas being discharged from the purification group 3 through the second pipe 35.

The condenser 32 which receives the process gas from the exchanger 31 through the first pipe 34 is, for example, connected to a cooling water line 16 and is provided to cool the process gas to a predefined condensation temperature of the contaminating substances which are released from the granular polymer material in the hopper. For example, in order to condense benzene and acetaldehyde, the cooling water line 16 transports water at approximately from 8 to 12° C. and the condenser 32 cools the process gas to approximately 20° C.

At the outlet from the condenser 32, there is provided a discharge pipe 17 which is configured to discharge the condensed contaminating substances towards a collection tank 7 for the subsequent disposal thereof.

The filter 33 which receives the process gas from the condenser 32 through the third pipe 36 contains activated carbon which is capable of absorbing any contaminating substances which are still present in the process gas because they were not condensed in the condenser 32. In a greatly preferred embodiment, the filter 33 comprises a plurality of filtering elements, which are preferably cylindrical and which contain activated carbon. It will be appreciated that the presence of a plurality of filtering elements reduces the costs of maintenance of the filter 33 because each element can be replaced independently of the others. The cylindrical formation, instead, serves to reduce the resistance to advance of the process gas flow through the filtering elements.

The plant 1 operates in the modes described below.

The granular polymer material, in this example a mixture at least partially formed by rPET, is loaded by means of the loading line 4 in the hopper 2, where it is dried by means of contact with the process gas which is introduced into the hopper 2 through the process gas circuit 10.

The process gas is moved along the process gas circuit 10 as a result of the action of the blowers of the movement unit 30.

In the dehumidification and heating unit 20, the process gas is heated by means of a heating device until reaching a temperature suitable for supply to the hopper, such as, for example, a temperature of 90° C., and is dehumidified by means of one of the towers 21, 22 until reaching a suitable level of residual humidity, such as, for example, 20 ppm of water.

The process gas is then introduced into the hopper 2 through the inlet pipe 11 and the diffuser and then brought back into the circuit 10 by means of the outlet pipe 13.

The output temperature of the process gas is approximately 80° C. and, after passing through the cyclone separator 6 which retains the dust so as to prevent obstructions, the process gas can be supplied to the purification group 3.

The process gas is introduced into the purification group 3 through the first pipe 35 and, by means of the heat exchanger 31, the gas discharges heat, lowering its own temperature, for example, to approximately from 45 to 50° C.

At this point, the process gas passes through the condenser 32 and is subjected to an additional cooling as far as a suitable temperature for condensing the contaminating substances, for example, approximately 20° C. for condensing benzene and acetaldehyde.

The contaminating substances which are condensed in this manner are separated from the process gas and conveyed towards the tank 7 through the discharge pipe 17.

The process gas being discharged from the condenser 32 reaches the filter 33 through the third pipe 36.

In the filter 33, the process gas passes through filtering elements which contain activated carbon which absorbs any contaminating substances which are not condensed in the preceding passage through the condenser 32.

Afterwards, the process gas again passes through the heat exchanger 31. In this case, however, the process gas passes through the second pipe 35 and, being at a temperature lower than the process gas of the first pipe 34, takes on heat from the latter until reaching a temperature suitable for the subsequent dehumidification step, for example, a temperature of approximately 60° C.

At this point, the process gas returns to the dehumidification and heating unit 20 through the pipe 15.

In the embodiment illustrated, the process gas being introduced into the purification group 10 has the following characteristics: temperature of approximately 80° C.; humidity of approximately 1000 parts per million (ppm); approximately 65 parts per billion (ppb) of benzene; and approximately 1.2 ppm of acetaldehyde. In the same embodiment, the process gas being discharged from the purification group 10 has the following characteristics: temperature of approximately 60° C.; humidity of approximately 1100 ppm; benzene less than 10 ppb; and acetaldehyde less than 0.4 ppm.

Still with reference to the embodiment illustrated, the plastics material being introduced into the hopper 2 has the following characteristics: temperature of approximately 20° C.; humidity of approximately 2500 ppm; approximately 150 ppb of benzene; and approximately 3.25 ppm of acetaldehyde. The plastics material being discharged from the hopper 2 has the following characteristics: temperature of approximately 175° C.; humidity less than 40 ppm; benzene less than 20 ppb; and acetaldehyde less than 1 ppm.

The drying plant 1 carries out the optimum drying of the granular polymer material contained in the hopper 2, achieving a relevant reduction of the content of contaminating substances in the material itself and in the process gas used for drying the material.

The invention thereby solves the problem set out, further obtaining plastics material with a high level of quality based on recycled PET.

1. A plant (1) for drying granular polymer material, comprising a hopper (2), in which granular polymer material is dried, and a process gas circuit (10), which is configured to supply a process gas to the hopper (2) in order to dry the granular polymer material, wherein the process gas circuit (10) comprises:
a dehumidification and heating unit (20) which is configured to dehumidify and heat the process gas to predefined humidity and temperature values for supply to the hopper (2), respectively,
a purification group (3) which is positioned at an outlet of the hopper (2) and upstream of the dehumidification and heating unit (20) and which is configured to purify the process gas from contaminating substances which are released by the granular polymer material in the hopper (2), and
a cyclone separator (6) which is positioned at the outlet of the hopper (2) and upstream of the purification group (3), and which is configured to separate a dust of the polymer material granules from the process gas being introduced into the purification group, wherein the purification group (3) comprises:
a condenser (32) which is configured to cool the process gas to a predefined condensation temperature of the contaminating substances so as to separate from the process gas the contaminating substances thus condensed,
a filter (33) which is positioned at the outlet of the condenser (32) and which contains activated carbon capable of absorbing non-condensed contaminating substances.

2. The plant (1) according to claim 1, wherein the condenser (32) is configured to cool the process gas to a temperature between 10° C. and 30° C.

3. The plant (1) according to claim 1, wherein the condenser (32) is configured to cool the process gas to a temperature between 15° C. and 25° C.

4. The plant (1) according to claim 1, wherein the condenser (32) is configured to cool the process gas to a temperature of substantially 20° C.

5. The plant (1) according to claim 1, wherein the purification group (3) comprises a first pipe (34) for the process gas which is being discharged from the hopper (2) and upstream of the condenser (32), a second pipe (35) for the process gas which is being discharged from the filter (33) and upstream of the dehumidification and heating unit (20), and a heat exchanger (31) which includes the first pipe (34) and second pipe (35), the heat exchanger (31) being configured to exchange heat between the process gas being introduced into the purification group (3) through the first pipe (34) and the process gas being discharged from the purification group (3) through the second pipe (35).

6. The plant (1) according to claim 1, wherein the process gas circuit (10) comprises a movement unit (30) which is configured to move the process gas along the process gas circuit (10) between the dehumidification and heating unit (20), the hopper (2) and the purification group (3), and and to move the process gas in the purification group (3) between the heat exchanger (31), the condenser (32) and the filter (33).

7. The plant (1) according to claim 1, wherein the process gas circuit (10) is a closed circuit.

8. The plant (1) according to claim 1, further comprising, downstream of the dehumidification and heating unit (20), an inlet pipe (11), by means of which the process gas is introduced into the hopper (2), and a sampling location (12), along the inlet pipe (11), for sampling the process gas.

9. The plant (1) according to claim 1, further comprising, downstream of the dehumidification and heating unit (20), an inlet pipe (11), by means of which the process gas is introduced into the hopper (2), and a diffuser mounted at the end of the inlet pipe (11), which is introduced into the granular polymer material contained in the hopper (2).

10. The plant (1) according to claim 1, further comprising a bypass valve of the process gas which allows the purification group (3) to be excluded from the process gas circuit (10).

11. The plant (1) according to claim 1, wherein the filter (33) comprises a plurality of filtering elements which contain activated carbon.

12. The plant (1) according to claim 11, wherein the filtering elements are cylindrical.

13. The plant (1) according to claim 1, wherein the condenser (32) is connected to a cooling water line (16).

14. The plant (1) according to claim 1, wherein the process gas circuit (10) comprises a movement unit (30), comprising at least one blower, in order to move the process gas along the process gas circuit (10).

15. The plant (1) according to claim 1, wherein the movement unit (30) is connected downstream of the cyclone separator (6) with respect to the process gas flow.
